(19) United States
(12) Patent Application Publication
(10) Pub. No.: US 2007/0186814 A1
(43) Pub. Date: Aug. 16, 2007

(54) Effect-pigmented powdery coating substances, method for the production and use thereof

(75) Inventors: Norbert Schneider, Altrip (DE); Susanne Piontek, Munster (DE); Christopher Hilger, Munster (DE); Jan Berg, Munster (DE); Gunther Etzrodt, Stuttgart (DE); Michael Mauss, Neustadt (DE)

Correspondence Address: BASF CORPORATION;Patent Department, 1609 BIDDLE AVENUE, MAIN BUILDING, WYANDOTTE, MI, 48192, US

(73) Assignee: BASF COATING AG, Munster (DE)

(21) Appl. No.: 10/595,105

(22) PCT Filed: Sep. 8, 2004
(86) PCT No.: PCT/EP04/52307

§ 371 Date: Aug. 9, 2006

(30) Foreign Application Priority Data
Sep. 19, 2003 (DE) 103 43 393.7

(51) Int. Cl. C09C 1/62

(52) U.S. Cl. 106/403

(57) ABSTRACT

Pulverulent coating materials composed of (A) leaflet-shaped particles having a ratio of laminar diameter D to layer thickness d, i.e., D:d of from 100:1 to 10:1, comprising at least one leaflet-shaped effect pigment in complete or near-complete parallel orientation to the surface of the leaflet-shaped particles, and (B) transparent, dimensionally stable, non-leaflet-shaped particles or leaflet-shaped particles having a ratio of laminar diameter D to layer thickness d, i.e., D:d of <10:1 which are free from leaflet-shaped effect pigments; process for preparing them, and their use.

The present invention relates to novel pulverulent coating materials pigmented with effect pigments. The present invention also relates to a novel process for preparing pulverulent coating materials pigmented with effect pigments. The present invention further relates to the use of the novel pulverulent coating materials pigmented with effect pigments for producing color and/or effect coatings.

The optical properties, such as brilliance, lightness, and color flop, of an effect coating depend on the degree of parallel orientation of the leaflet-shaped effect pigments in the cured coating with respect to its surface. Liquid coating materials are formulated in such a way that, in the course of drying and curing, the leaflet-shaped effect pigments are able to orient themselves parallel to the surface of the resultant coating. In the case of pulverulent coating materials, especially powder coating materials, this is not possible, since in the course of curing, particularly of thermal curing, the pulverulent coating materials do not run through the kind of low-viscosity phase experienced by the liquid coating materials. Pulverulent coating materials or powder coating materials are composed, as is known, of approximately spherical, dimensionally stable particles, or resin particles, which coalesce during cure, in particular during thermal curing, but do not flow completely into one another. In the preparation of effect powder coating materials, especially those which impart a metallic effect, by the bonding method which is normally employed, the leaflet-shaped effect pigments are fixed uniformly on the surface of the dimensionally stable particles or resin particles. Consequently, following the application of the powder coating materials, the leaflet-shaped effect pigments are oriented randomly in all directions. This random directional distribution is then also found in the coating produced from them. This results in only a very low degree, if any at all, of orientation of the leaflet-shaped effect pigments parallel to the surface of the coating. For this reason the coatings produced from powder coating materials pigmented with effect pigments do not have the same brilliance, lightness, and color flop as the coatings produced from liquid coating materials pigmented with the corresponding effect pigments.

Pulverulent coating materials or powder coating materials have the decisive advantage over their liquid counterparts, especially those comprising organic solvents, of releasing only very small amounts, if any, of volatile organic compounds in the course of their application and curing. Moreover, the pulverulent overspray obtained in the course of the powder coating operation is very easy to collect and re-use. Consequently there has been no lack of attempts to improve the incorporation of leaflet-shaped effect pigments into powder coating materials and, with it, the degree of orientation of these leaflet-shaped effect pigments parallel to the surface of the coating.

It is known, for instance, from German patent application DE 100 18 581 A1 that the incorporation and orientation of leaflet-shaped aluminum effect pigments can be enhanced by pasting them with nonionic surfactants.

German patent application DE 100 27 294 A1 proposes enhancing the incorporation and orientation through the use of leaflet-shaped aluminum effect pigments having a particularly broad particle size distribution.

According to German patent application DE 100 27 270 A1 the orientation parallel to the surface can be enhanced through the use of leafing aluminum effect pigments, which, as is known, float in low-viscosity, liquid films of coating materials.

In German patent application DE 100 27 267 A1 it is proposed that the incorporation and orientation of leaflet-shaped effect pigments be enhanced by embedding them in oligomers or polymers having a melting point or melting range of at least 10° C. below the melting point or melting range of the binders of the powder coating materials. Whether the particles resulting from the embedding operation are leaflet-shaped, and whether the resultant coatings contain the leaflet-shaped effect pigments in complete or virtually complete parallel orientation to their surface are not disclosed by DE 100 27 267 A1.

From German patent applications DE 100 58 860 A1 and DE 101 20 770 A1 it is known to apply leaflet-shaped effect pigments to transparent, dimensionally stable particles or powder coating materials by spraying dispersions of leaflet-shaped effect pigments in binder solutions into fluidized beds of the particles or powder coating materials.

The known measures all lead to a distinct improvement in the incorporation and orientation of leaflet-shaped effect pigments, with the consequence that the coatings in question have better optical properties and in some cases even obtain what has been referred to as automobile quality (cf. in this respect also European patent EP 0 352 298 B1, page 15, line 42 to page 17, line 40) and are suitable for overcoating top-class automobiles. However, this level of quality is not attained reliably and reproducibly in all cases, with the consequence that further improvement is necessary in the incorporation and orientation of leaflet-shaped effect pigments in pulverulent coating materials or powder coating materials.

From American patents U.S. Pat. Nos. 5,059,245 A1 and 5,171,363 A1 it is known to prepare leaflet-shaped interference pigments which give a particularly strong color flop (known as OVP, optically variable pigments) by generating the interference layers on the surface of a sheet in the same sequence in which they occur in the OVP. Subsequently the film is broken up, resulting in a dispersion of the OVP. These pigments can be incorporated, in the form of the dispersion, into inks and liquid coating materials. They are not suitable for incorporation into pulverulent coating materials or powder coating materials.

It is an object of the present invention to find new pulverulent coating materials, especially powder coating materials, which are pigmented with effect pigments, especially leaflet-shaped effect pigments, and which no longer have the disadvantages of the prior art but instead can be prepared easily and with great reproducibility and provide coatings having outstanding optical properties, in particular high brilliance, high lightness, and a particularly strong color flop, in which the effect pigments, especially the leaflet-shaped effect pigments, display a particularly high degree of orientation parallel to the surface of the coatings.

The invention accordingly provides the novel pulverulent coating materials composed of
(A) leaflet-shaped particles having a ratio of laminar diameter D to layer thickness d, i.e., D:d of from 100:1 to 10:1, comprising at least one leaflet-shaped effect pigment in complete or near-complete parallel orientation to the surface of the leaflet-shaped particles, and
(B) transparent, dimensionally stable, non-leaflet-shaped particles or leaflet-shaped particles having a ratio of laminar diameter D to layer thickness d, i.e., D:d of <10:1 which are free from leaflet-shaped effect pigments,
   and referred to below as “coating materials of the invention”.

The invention further provides the novel process for preparing the coating materials of the invention, which comprises
(I) dispersing at least one leaflet-shaped effect pigment in the aqueous and/or organic solution of at least one polymeric and/or oligomeric binder and
(II) applying the resulting dispersion (I)
   (II.1) to a temporary support by means of a directed application process which generates an orientation of the effect pigments into a particular preferential direction or
   (II.2) to a transparent layer which has been produced by a directed application process and is located on the temporary support, by means of an undirected application process which does not produce any orientation of the effect pigments into a particular preferential direction, and
(III) drying, or drying and curing, the resulting layer, (II.1) or (II.2),
(IV) detaching the resulting layer (III) from the temporary support, alone or in unison with the optically transparent layer, in the form of leaflet-shaped pieces,
(V) comminuting and classifying the resulting leaflet-shaped pieces (IV) to give the leaflet-shaped particles (A), and
(VI) mixing the leaflet-shaped particles (A) with the particles (B).

The novel process for preparing the coating materials of the invention is referred to below as “process of the invention”.

Further subject matter of the invention will emerge from the description.

In the light of the prior art it was surprising and unforeseeable for the skilled worker that the object on which the present invention was based could be achieved by means of the coating materials and process of the invention. In particular it was surprising that the coating materials of the invention could be produced with particular ease and very good reproducibility and gave coatings of the invention having outstanding optical properties, in particular high brilliance, high lightness, and a particularly strong color flop, in which the effect pigments, particularly the leaflet-shaped effect pigments, displayed a particularly high degree of orientation parallel to the surface of the coatings of the invention. A particular surprise, however, was that the coatings of the invention had the automobile quality and were therefore suitable for the finishing of automobiles, especially top-class automobiles.

The coating materials of the invention are composed of the two constituents (A) and (B).

Constituent (A) comprises leaflet-shaped particles (A) having a ratio of laminar diameter D to layer thickness d, i.e., D:d, of from 100:1 to 10:1, in particular from 80:1 to 20:1, and comprising at least one leaflet-shaped effect pigment in complete or virtually complete parallel orientation to the surface of the leaflet-shaped particles (A).

The number and nature of the effect pigments are guided by the optical effect intended. This can be a metallic effect, a pearlescent effect or a very strong color flop, from red to blue or from green to gold, for, example. The optical effects may also be combined with one another.

The leaflet-shaped effect pigments are preferably selected from the group consisting of aluminum pigments, gold bronzes, fire-colored bronzes, iron oxide-aluminum pigments, pearl essence, basic lead carbonate, bismuth oxychloride, metal oxide-mica pigments, interference pigments displaying a strong color flop (OVP), micronized titanium dioxide, leaflet-shaped graphite, leaflet-shaped iron oxide, and liquid-crystalline pigments. These effect pigments are customary and known and are described in, for example, Römpp-Online, Georg Thieme Verlag, Stuttgart, N.Y. 2002, “Effect Pigments”, or patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. Nos. 4,828,826 A1, 5,244,649 A1, 5,059,245 A1 or 5,171,363 A1.

The particle size of the leaflet-shaped effect pigments, determined by the laser diffraction method, may likewise vary very widely. They preferably contain no fine fraction or only a very small fraction of fines, i.e., particles with a size <5 μm. They preferably contain not more than 10% of particles with a size >100 μm. In particular their average particle size is from 5 to 50 μm. By average particle size is meant the 50% median figure determined by the laser diffraction method; i.e., 50% of the particles have a diameter ≦ the median and 50% of the particles have a diameter ≧ the median.

The particle size of the leaflet-shaped particles (A) laminarly is preferably from 50 to 300 μm, more preferably from 60 to 250 μm, and in particular, from 80 to 200 μm. The thickness of the leaflet-shaped particles (A) is preferably from 1 to 50 μm, in particular from 1 to 20 μm.

The amount of the leaflet-shaped effect pigments in the leaflet shaped particles (A) may vary very widely and is guided in particular by the dispersibility and opacity of the effect pigments and the intensity of the optical effects intended. The amount is preferably from 0.1 to 60% by weight, more preferably from 1 to 50% by weight, and in particular from 1 to 40% by weight, based in each case on (A).

The leaflet-shaped particles (A) comprise at least one, especially one, transparent, especially clear, oligomeric and/or, polymeric binder. Regarding the meaning of the properties “polymeric” and “oliogmeric” refer to German patent application DE 100 27 270 A1, page 5, paragraph [0065].

The binders are preferably selected from the group consisting of
thermoplastic, homopolymeric polyaddition resins and polycondensation resins curable physically, thermally, with actinic radiation or both thermally and with actinic radiation;
thermoplastic, random, alternating and/or block, linear, branched and/or comb, copolymeric polyaddition resins and polycondensation resins curable physically, thermally, with actinic radiation or both thermally and with actinic radiation;
thermoplastic homopolymers of ethylenically unsaturated monomers, curable physically, thermally, with actinic radiation or both thermally and with actinic radiation; and
random, alternating and/or block, linear, branched and/or comb copolymers of ethylenically unsaturated monomers, curable physically, thermally, with actinic radiation or both thermally and with actinic radiation.

By actinic radiation is meant, here and below, electromagnetic radiation, such as near infrared (NIR), visible light, UV radiation, X-rays or gamma rays, especially UV radiation, and corpuscular radiation, such as electron beams, beta radiation, proton beams, neutron beams or alpha radiation, especially electron beams.

Suitable binders curable thermally and/or with actinic radiation are customary and known and are described in, for example, German patent application DE 100 27 270 A1, page 5, paragraph [0067], to page 10, paragraph [0100].

Suitable physically curable binders are likewise customary and known and are described in, for example, German patent application DE 101 20 770 A1, column 11, paragraph [0082], to column 13, paragraph [0095].

The binders selected are of course always those which do not enter into any unwanted interactions, particularly no decomposition reactions, with the particular leaflet-shaped effect pigments used.

It is of advantage if the binders are compatible with the below-described binders of the particles (B). It is further of advantage if the binders have a refractive index like that of the binders of the particles (B). It is additionally of advantage if the binders have a melting point or melting range situated at least 10° C. below the melting point or melting range of the binders of the particles (B) (cf. in this respect German patent application DE 100 27 267 A1, page 4, paragraphs [0034] to [0036], [0040] and [0041]). It is of advantage not least if the minimum film-forming temperature of the binders is at least 0° C., preferably at least 10 ° C., more preferably at least 15° C., very preferably at least 20 ° C. and in particular at least 25° C. The minimum film-forming temperature can be determined by drawing down an aqueous dispersion of the binder onto a glass plate using a doctor blade or applying a finely divided binder powder to a glass plate and heating it in a gradient oven. The temperature at which the pulverulent layer forms a film is designated the minimum film-forming temperature. For further details refer to Römpp Lexikon Lacke und Druckfarben, Georg Thieme Verlag, Stuttgart, N.Y., 1998, “Minimum film-forming temperature”, page 391.

The leaflet-shaped particles (A) may further comprise at least one additive in customary and known amounts. The additives are preferably selected from the group consisting of customary and known constituents of powder coating materials. Examples of suitable additives of this kind are crosslinking agents, adjuvants and color pigments, fillers, and dyes, as described in German patent application DE 100 27 270 A1, page 4, paragraphs [0046] to [0050], page 5, paragraph [0053] and page 11, paragraph [0103] to page 12, paragraph [0107].

The leaflet-shaped particles (A) may further comprise at least one, especially one, transparent, in particular optically clear layer which can be prepared by a directed application process. Examples of directed application processes are casting, knife coating, roller coating or extrusion coating processes. The transparent layer, is preferably from 1 to 30 μm, in particular from 1 to 20 μm, thick. The thickness of the transparent layer and the thickness of the layer of the leaflet-shaped particles (A) that contains the leaflet-shaped effect pigments are preferably chosen so as not to exceed an overall layer thickness of 50 μm, in particular 20 μm.

The transparent layer comprises or consists of at least one of the above-described oligomeric and/or polymeric binders. It may further comprise the above-described additives, with the exception of opaque pigments. Viewed per se it may be cured physically, thermally, with actinic radiation or both thermally and with actinic radiation, in particular physically.

The leaflet-shaped particles (A), or the matrices in which the leaflet-shaped effect pigments are embedded, can be cured physically, thermally, with actinic radiation or both thermally and with actinic radiation. They are preferably physically cured.

The coating materials of the invention are further composed of constituent (B).

Constituent (B) comprises transparent, in particular optically clear, dimensionally stable, non-leaflet-shaped particles, or leaflet-shaped particles having a ratio of laminar diameter D to layer thickness d, i.e., D:d, of <10:1, especially <5:1, which are free from leaflet-shaped effect pigments.

“Dimensionally stable” means that, under the customary and known conditions of storage and application of pulverulent coating materials, especially powder coating materials, the transparent, dimensionally stable particles undergo very little if any agglomeration and/or breakdown into smaller particles, and essentially retain their original form even when subject to shearing forces.

The transparent, dimensionally stable particles (B) are preferably spherical or substantially spherical.

“Substantially spherical” means that the transparent, dimensionally stable particles (B) in question approximately have a more or less regular spherical form and are, for example, cuboidal, oviform or cylindrical. They may have an irregular surface. Transparent, dimensionally stable particles (B) of this kind are formed above all in the comminution of coarse granules in grinding equipment, such as is usually carried out during the preparation of powder clearcoat materials.

“Spherical” means that the transparent, dimensionally stable particles (B) in question have the form of a sphere with a substantially smooth surface. Transparent, dimensionally stable particles (B) of this kind are produced above all in the preparation of the particles (B) by means of dispersing methods (cf., e.g., European patent EP 0 960 152 B1).

The particle size of the dimensionally stable particles (B) may vary very widely and is guided in particular by the intended use of the coating materials of the invention. The average particle size, as defined above, is preferably from 20 to 500 μm, more preferably from 20 to 250 μm, and in particular from 20 to 100 μm. With particular preference narrow particle size distributions are set, as are described, for example, in European patents EP 0 666 779 B1 or EP 0 960 152 B1.

The transparent, dimensionally stable particles (B) can be curable physically, thermally, with actinic radiation or both thermally and with actinic radiation (cf. in this respect also German patent application DE 100 27 270 A1, page 5, paragraphs [0060] to [0063]). Preferably they are curable physically or thermally. They can have the material compositions described, for example, in German patent application DE 100 27 270 A1 page 5, paragraph [0064], to page 12, paragraph [0107]. They may also include the pigments, fillers, and dyes described in German patent application DE 100 27 270 A1, page 4, paragraphs [0046] to [0050], and page 5, paragraph [0053], provided these components are not opaque.

The mixing ratio of leaflet-shaped particles (A) to transparent, especially optically clear, dimensionally stable particles (B) may vary very widely and is guided in particular by the amount of leaflet-shaped effect pigments intended for the coatings of the invention produced from the coating materials of the invention. The mixing ratio is preferably from 1:1 to 1:10, in particular from 1:1.5 to 1:5.

The coating materials of the invention may be prepared by means of any of a very wide variety of processes They are preferably prepared by means of the process of the invention.

In step (I) of the process of the invention at least one of the above-described, leaflet-shaped effect pigments is dispersed in the aqueous and/or organic solution and at least one of the above-described polymeric and/or oligomeric binders.

Examples of suitable organic solvents are known from D. Stoye and W. Freitag (editors), “Paints, Coatings and Solvents”, Second, Completely Revised Edition, Wiley-VCH, Weinheim, N.Y., 1998, “14.9. Solvent Groups”, pages 327 to 373.

It is preferred to use organic solvents which do not enter into any disruptive interactions with the constituents of the resulting dispersions (I), and in particular do not damage the effect pigments, and which have a high solvency for the binders and also for any other constituents of the dispersions (I) present, such as the above-described additives, examples being customary and known crosslinking agents for thermally curable binders, and which evaporate readily under normal drying conditions. The skilled worker can therefore select suitable organic solvents easily on the basis of their known solvency and their reactivity. Examples of especially suitable organic solvents are described in German patent application DE 100 57 165 A1, page 6, paragraph [0056].

The solids content of the dispersions (I) may vary very widely and is guided in particular by the solubility of the binders in water and/or organic solvents and by the dispersibility of the particular effect pigments used. The effect pigment/binder ratio may also vary very widely and is guided in particular by the dispersing capacity of the binders for the particular effect pigments used. The solids content of the dispersions (I) is preferably from 10 to 60% by weight, in particular from 10 to 40% by weight, based in each case on the dispersion (I). The pigment/binder ratio is preferably from 1:100 to 1:1, in particular from 1:50 to 1:2. The amount of effect pigments in the dispersions (I) is preferably from 1 to 30% by weight, in particular from 1 to 20% by weight, based in each case on the dispersion (I).

In a first alternative (II.1) of step (II) of the process of the invention the dispersion (I) is applied to a temporary support by means of a directed application process which generates an orientation of the effect pigments into a particular preferential direction. Suitable directed application processes are described above.

In a second alternative (II.1) the dispersion (I) is applied to a transparent, especially optically clear, layer produced by means of a directed application process and located on a temporary support, by means of an undirected application process which does not produce any orientation of the effect pigments into a particular preferential direction.

Examples of undirected application processes are spray application processes.

The temporary support is preferably constructed of plastic, metal or glass. Their surface is preferably smooth with antistick properties.

The transparent layers applied by a directed application process may have a very wide variety of material compositions. For example they may consist of the above-described oligomeric and polymeric binders. Alternatively they may have the compositions of powder coating materials as described, for example, in German patent application DE 100 27 270 A1, page 5, paragraph [0064], to page 12, paragraph [0107], except that they contain no opaque pigments. They may be curable physically, thermally, with actinic radiation or both thermally and with actinic radiation. Their thickness is preferably from 1 to 30 μm.

In the case of alternative (II.1) in step (II) of the process the layers (II.1) are applied in a wet layer thickness such that, after the drying or drying and curing, preferably by means of the above-described curing methods, in particular by drying and physical curing, of the layers (II.1) the resulting dry layer thickness in step (III) of the process is from 1 to 50 μm, in particular from 1 to 20 μm.

In the case of alternative (II.2) in step (II) of the process the layers (II.2) are applied in a wet layer thickness such that, after the drying or drying and curing, preferably by means of the above-described curing methods, in particular by drying and physical curing, of the layers (II.2) the resulting dry layer thickness in step (III) of the process is from 1 to 49 μm, in particular from 1 to 20 μm. The dry layer thickness of the layers (II.2) is preferably chosen such that together with the transparent layer the overall layer thickness which results is from 2 to 50 μm, in particular from 2 to 20 μm.

In step (IV) of the process of the invention the layers (III) resulting in step (III) of the process, are detached from the temporary support alone [alternative (II.1)] or in unison with the transparent, especially optically clear, coating [alternative (II.2)]. This is preferably effected by means of ultrasound or by mechanical exposure, in particular by exposure to a sharp jet of liquid, in which case care should be taken to ensure that the liquids used do not redissolve the layers (III). Detachment of the layers (III) from the temporary supports results in the leaflet-shaped pieces (IV).

In step (V) of the process the leaflet-shaped pieces (IV) are comminuted and classified according to particle size. For these purposes it is possible to use the grinding equipment and screening apparatus which are customary and known in the field of pulverulent coating materials. The resultant leaflet-shaped particles (A) generally have a particle size which is greater than that of the leaflet-shaped effect pigment present therein. The leaflet-shaped effect pigments present in the leaflet-shaped particles (A) are aligned completely or virtually completely parallel to the surface of the particles (A).

For the preparation of the coating materials of the invention the leaflet-shaped particles (A) are mixed, in step (VI) of the process of the invention, with the above-described, transparent, especially optically clear, dimensionally stable, pulverulent particles (B). It is preferred to employ the mixing ratios described above. In terms of method the mixing of (A) and (B) has no special features; instead, the customary and known techniques and apparatus for the dry mixing of pulverulent substances are employed.

The process of the invention yields the coating materials of the invention in a way which is particularly simple and outstandingly reproducible.

The coating materials of the invention can be processed further outstandingly by means of the customary and known application techniques for powder coating materials, as described, for example, in the BASF Lacke+Farben AG product information “Pulverlacke”, 1990, or the BASF Coatings AG brochure “Pulverlacke, Pulverlacke für industrielle Anwendungen”, January 2000. Following their application they can be cured in a simple way physically, thermally, with actinic radiation or both thermally and with actinic radiation, in particular physically or thermally, as is described in, for example, German patent application DE 100 27 270 A1, page 15, paragraphs [0140] to [0148].

The coating materials of the invention are outstandingly suitable in particular for producing color and/or effect coatings on substrates, especially single-coat or multicoat paint systems.

It is a very particular advantage of the coating materials of the invention that they are suitable in particular for coating substrates, such as bodies of means of transport, including aircraft, watercraft, muscle-powered vehicles, and motor vehicles, and also parts thereof, the interior and exterior of buildings and parts thereof, furniture, windows, doors, small industrial parts, coils, containers, packaging, white goods, sheets, optical components, electrical components, mechanical components or hollow glassware.

Owing to the advantageous properties of the coating materials of the invention the coatings of the invention have outstanding optical properties, particularly as regards brilliance, lightness and the color flop. The coatings of the invention exhibit automobile quality and can therefore also be used for finishing top-class automobiles.

### EXAMPLES

### Example 1

The Preparation of Leaflet-shaped Particles (A)

20 parts by weight of a leaflet-shaped aluminum effect pigment (Alphate® 7670 NS from Toyal; calculated on the solids content) were gently dispersed in a solution of 80 parts by weight of polymethyl methacrylate of designation Plexiglas® 8N glass-clear molding compound (Röhm GmbH & Co. KG) and 320 parts by weight of acetone in a dissolver for ten minutes. The resulting dispersion was applied to a polyethylene terephthalate substrate in a precision coating unit using a blade coater. The gap between substrate and coating blade was set at 60 μm. The applied layer was dried at 80° C. in the unit. At a coating rate of 30 m/minute a layer with a thickness d of 5±0.2 μm was obtained. Within the layer the leaflet-shaped aluminum effect pigments were arranged completely parallel to the surface.

In a continuously operating unit the layer was delayered by means of a sharp jet of water. The resulting mixture of water and leaflet-shaped pieces was taken off through a suction filter and the filter product was dried at 80° C. for twelve hours. Subsequently the leaflet-shaped pieces were ground in a cutting mill and the leaflet-shaped particles (A) with a laminar diameter D of from 90 to 180 μm were separated off for further use.

### Example 2

The Preparation of a Coating Material from Constituents (A) and (B)

32.5 parts by weight of the leaflet-shaped particles (B) from example 1 were dry-mixed with 67.5 parts by weight of a commercially customary powder clearcoat material based on methacrylate copolymers. The resulting coating material was outstandingly suitable for producing effect coating systems.

### Examples 3 and C1 (Comparative)

The Production of Effect Coating Systems

Example 3 was carried out using the coating material from example 2.

Comparative example C1 was carried out using a powder coating material produced by the customary and known standard bonding method and pigmented with the aluminum effect pigment (Stabil® 7608 from Benda-Lutz).

The coating materials each contained the same amount of aluminum effect pigment. They were applied electrostatically to metal test panels and baked so as to give the same layer thickness in each case. The lightness L* was measured using the instrument Byk® Colorview using illuminants D65/TL and 84/A and the measurements were evaluated in accordance with CIELAB. The coating of example 3 gave a lightness L* of 71.5, which was substantially higher than the lightness L* of 57 for the coating from comparative example C1.

1. A pulverulent coating material comprising
(A) leaflet-shaped particles having a ratio of laminar diameter D to layer thickness d, D:d of from 100:1 to 10:1, comprising at least one leaflet-shaped effect pigment in complete or near-complete parallel orientation to the surface of the leaflet-shaped particles, and
(B) transparent, dimensionally stable, non-leaflet-shaped particles or leaflet-shaped particles having a ratio of laminar diameter D to layer thickness d, i.e., D:d of <10:1 which are free from leaflet-shaped effect pigments.

2. The coating material as claimed in claim 1, wherein the mixing ratio of (A) to (B) is from 1:1 to 1:10.

3. The coating material as claimed in claim 1, wherein the particle size of the leaflet-shaped particles (A) laminarly is from 50 to 300 μm.

4. The coating material as claimed in claim 1, wherein the leaflet-shaped particles (A) are from 50 μm thick.

5. The coating material as claimed in claim 1, wherein the leaflet-shaped effect pigments are selected from the group consisting of aluminum, gold bronzes, fire-colored bronzes, iron oxide-aluminum, pearl essence, basic lead carbonate, bismuth oxychloride, metal oxide-mica, interference pigments displaying a strong color flop, micronized titanium dioxide, leaflet-shaped graphite, leaflet-shaped iron oxide, and liquid-crystalline pigments.

6. The coating material as claimed in one claim 1, characterized in that the leaflet-shaped particles (A) comprise at least one oligomeric and/or polymeric binder.

7. The coating material as claimed in claim 6, wherein the oligomeric and polymeric binders are selected from the group consisting of
thermoplastic, homopolymeric polyaddition resins and polycondensation resins curable physically, thermally, with actinic radiation or both thermally and with actinic radiation;
thermoplastic resins selected from at least one of, random, alternating, block, linear, branched, or comb, copolymeric polyaddition resins or polycondensation resins, curable by at least one of physically, thermally, or with actinic radiation;
thermoplastic homopolymers of ethylenically unsaturated monomers, curable by at least one of physically, thermally, or actinic radiation; and
random copolymers selected from at least one of, alternating, block, linear, branched, or comb copolymers of ethylenically unsaturated monomers, curable by at least one of physically, thermally, or with actinic radiation.

8. The coating material as claimed in claim 1, wherein the particles (A) further comprise at least one additive.

9. The coating material as claimed in claim 1, wherein the particles (A) comprise at least one transparent layer which is produced by a directed application process.

10. The coating material as claimed in claim 9, wherein the transparent layer which is produced by a directed application process is from 1 to 30 μm thick.

11. The coating material as claimed in claim 9, wheiein the transparent layer which is produced by a directed application process where said layer comprises at least one of an oligomeric or polymeric binder.

12. The coating material as claimed claim 1, wherein the particles (B) are spherical or substantially spherical.

13. The coating material as claimed in claim 1, wherein the particles (B) are optically clear.

14. The coating material as claimed in claim 1, wherein the particles (B) are cured by at least one of physically, thermally, or with actinic radiation.

15. The coating material as claimed in claim 1, wherein the particles (B) have an average size of from 20 to 500 μm.

16. A process for producing a pulverulent coating material as claimed in claim 1, which comprises
(I) dispersing at least one leaflet-shaped effect pigment in the aqueous and/or organic solution of at least one of a polymeric or oligomeric binder and
(II) applying the resulting dispersion (I) to one of
(II.1) a temporary support by means of a directed application process which generates an orientation of the effect pigments into a particular preferential direction or
(II.2) a transparent layer which has been produced by a directed application process and is located on the temporary support, by means of an undirected application process which does not produce any orientation of the effect pigments into a particular preferential direction, and
(III) drying, or drying and curing, the resulting layer (II.1) or (II.2),
(IV) detaching the resulting layer (III) from the temporary support, alone or in unison with the transparent layer, in the form of leaflet-shaped pieces,
(V) comminuting and classifying the resulting leaflet-shaped pieces (IV) to give the leaflet-shaped particles (A), and
(VI) mixing the leaflet-shaped particles (A) with the particles (B).

17. The process as claimed in claim 16, wherein the directed application process is a one of a casting, knife coating, roller coating or extrusion coating process.

18. The process as claimed in claim 16, wherein the undirected application process is a spray application process.

19. The process as claimed in claim 16, wherein the dry layer thickness of the dried, or dried and cured, layers (II.1) is from 1 to 50 μm and the dry layer thickness of the dried, or dried and cured, layers (II.2) is from 1 to 49 μm.

20. The process as claimed in claim 16, wherein the thickness of the transparent layer produced by a directed application process and located on the temporary support is from 1 to 30 μm.

21. The process as claimed in claim 16, wherein the temporary support is one of plastic, metal or glass.

22. The process as claimed in claim 16, wherein the layer (III) is dried and physically cured.

23. The process as claimed in claim 16, wherein the leaflet-shaped pieces (IV) are detached mechanically from the temporary support.

24. The process as claimed in one claim 16, wherein the mechanical detachment is brought about by exposure to a jet of liquid or by ultrasound.

25-27. (canceled)
